(19) United States
(12) Patent Application Publication
(10) Pub. No.: US 2019/0180352 A1
(43) Pub. Date: Jun. 13, 2019

(54) LOCATING ITEMS FROM A PERSONAL LIST

(71) Applicant: INTERNATIONAL BUSINESS MACHINES CORPORATION, ARMONK, NY (US)

(72) Inventors: NICHOLAS G. DANYLUK, LONG ISLAND CITY, NY (US); KAVITA SEHGAL, POUGHKEEPSIE, NY (US); DIANE M. STAMBONI, POUGHKEEPSIE, NY (US); SNEHA M. VARGHESE, FISHKILL, NY (US); JOHN S. WERNER, FISHKILL, NY (US); SARAH WU, KINGSTON, NY (US)

(21) Appl. No.: 15/837,175

(22) Filed: Dec. 11, 2017

(51) Int. Cl. G06Q 30/06; G06K 9/00; G06K 9/62; G06K 9/78

(52) U.S. Cl. CPC G06Q 30/0639; G06Q 30/0633; G06K 9/78; G06K 9/6202; G06K 9/00671

(57) ABSTRACT

Embodiments include methods, systems and computer program products for locating items in a store from a personal shopping list. Aspects include receiving, by a processor of a mobile device, a personal shopping list and obtaining images of items on the personal shopping list. Aspects also include receiving, by the processor of the mobile device, images of one or more shelves in the store and analyzing the images of one or more shelves in the store to identify items on the personal shopping list. Based on a determination that an identified item on the personal shopping list has been located in one of the images of the one or more shelves, aspects include generating a notification that the identified item has been located.

### BACKGROUND

The present disclosure relates to locating items that are on a list and more specifically to locating items in a store based on a personal shopping list using a mobile device.

Individuals waste a significant amount of time in stores trying to locate items from a personal shopping list. Often, a person might pass through an aisle without noticing that they passed by items from their personal shopping list and have to come back to that aisle later and look for the overlooked item. Due to the large size of some stores, looping back to aisles that were previously visited can be a time-consuming process. Alternatively, a person may waste time searching for products that are sold out and not see the label on the shelf indication where the product should have been. Furthermore, even though a product is on a person's personal shopping list, they may accidentally skip over the item or forget to look for it.

### SUMMARY

In accordance with an embodiment, a method for locating items in a store from a personal shopping list. The method includes receiving, by a processor of a mobile device, a personal shopping list and obtaining images of items on the personal shopping list. The method also includes receiving, by the processor of the mobile device, images of one or more shelves in the store and analyzing the images of one or more shelves in the store to identify items on the personal shopping list. Based on a determination that an identified item on the personal shopping list has been located in one of the images of the one or more shelves, the method includes generating a notification that the identified item has been located.

In accordance with another embodiment, a system for locating items in a store from a personal shopping list is provided. The system includes a storage medium readable by a processing circuit and storing instructions for execution by the processing circuit for performing a method. The method includes receiving, by a processor of a mobile device, a personal shopping list and obtaining images of items on the personal shopping list. The method also includes receiving, by the processor of the mobile device, images of one or more shelves in the store and analyzing the images of one or more shelves in the store to identify items on the personal shopping list. Based on a determination that an identified item on the personal shopping list has been located in one of the images of the one or more shelves, the method includes generating a notification that the identified item has been located.

In accordance with a further embodiment, a computer program product for locating items in a store from a personal shopping list includes a non-transitory storage medium readable by a processing circuit and storing instructions for execution by the processing circuit for performing a method. The method includes receiving, by a processor of a mobile device, a personal shopping list and obtaining images of items on the personal shopping list. The method also includes receiving, by the processor of the mobile device, images of one or more shelves in the store and analyzing the images of one or more shelves in the store to identify items on the personal shopping list. Based on a determination that an identified item on the personal shopping list has been located in one of the images of the one or more shelves, the method includes generating a notification that the identified item has been located.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram of an exemplary computer system capable of implementing one or more embodiments of the present invention;

FIG. 4 is a block diagram of a system for locating items in a store from a personal shopping list in accordance with an exemplary embodiment;

FIG. 5 is a flow diagram of a method for locating items in a store from a personal shopping list in accordance with an exemplary embodiment; and

FIG. 6 is a flow diagram of another method for locating items in a store from a personal shopping list in accordance with an exemplary embodiment.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, a process, a method, an article, or an apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

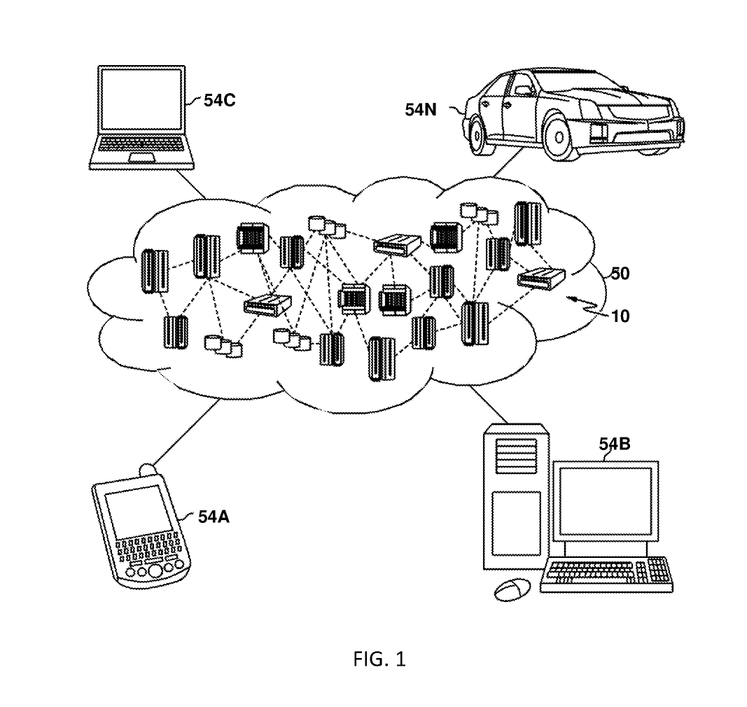

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

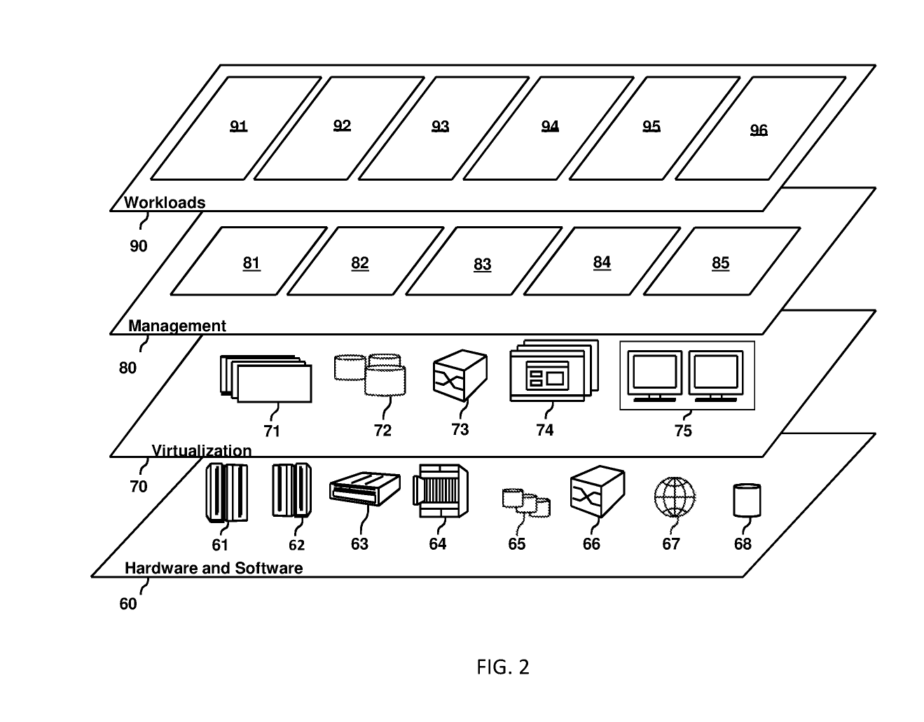

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and management of personal shopping list 96.

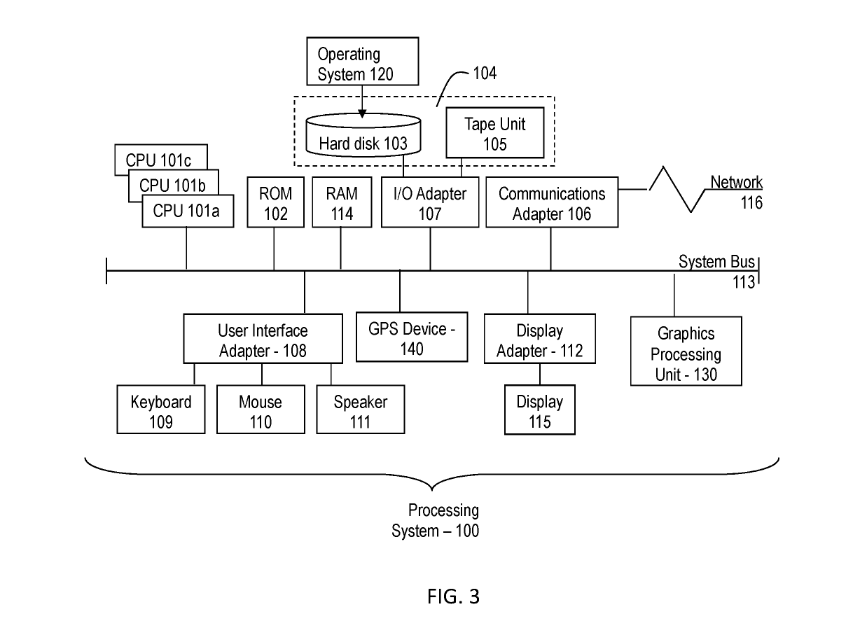

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read-only memory (ROM) 102 is coupled to the system bus 113 and may include a basic input/output system (BIOS), which controls certain basic functions of system 100.

FIG. 3 further depicts an input/output (I/O) adapter 107, a network adapter 106, and a GPS device 140 coupled to the system bus 113. I/O adapter 107 may be a small computer system interface (SCSI) adapter that communicates with flash storage, a hard disk 103 and/or tape storage drive 105 or any other similar component. I/O adapter 107, flash storage, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

Turning now to an overview of technologies that are more specifically relevant to aspects of the invention, which are related to locating items in a store from a personal shopping list. In exemplary embodiments, a user of a mobile device inputs a personal shopping list into an application on the mobile device. Upon entering a store, the user can enable a shopping mode on the application which will activate one or more cameras of the mobile device. The images, or video, captured by the mobile device are analyzed and an alert is generated upon the detection of one of the items on the personal shopping list. In exemplary embodiments, after the alert is generated the user may look at the mobile device screen which can highlight the location of the identified item on the store shelf.

In one embodiment, the shopping carts in the stores may have a holder designed to receive the mobile device and allow the cameras of the mobile device to capture images of shelves on both sides of the cart. In another embodiment, the shopping cart may include cameras which can be used to scan the shelves of the store for the items on the personal shopping list.

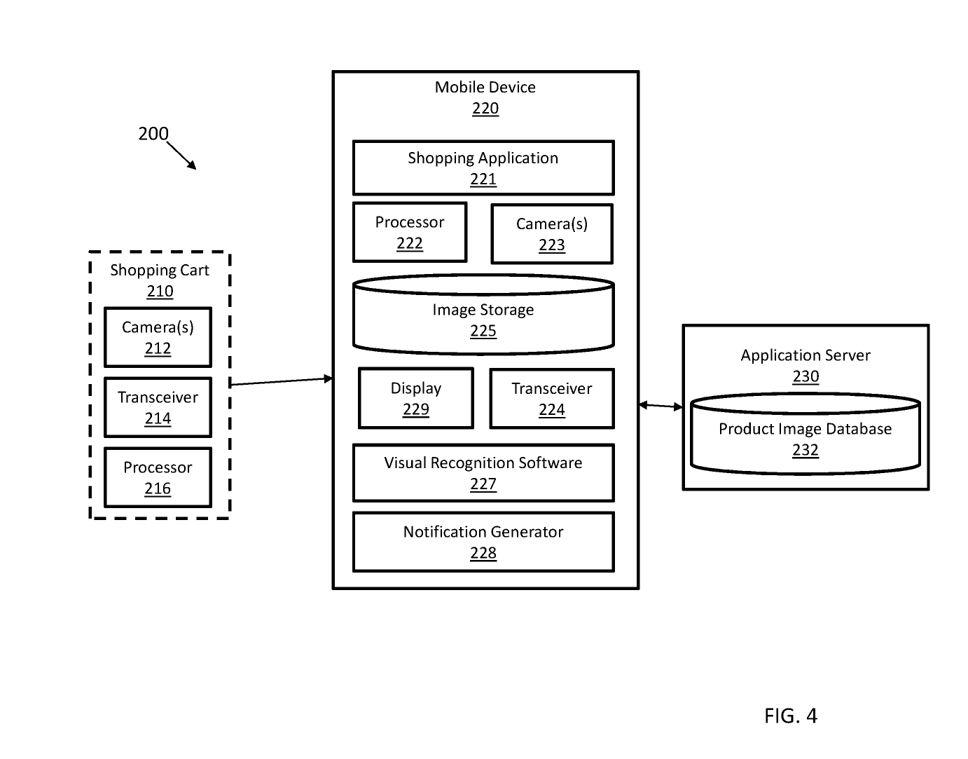

Referring now to FIG. 4, a system 200 for locating items in a store from a personal shopping list is shown. As illustrated the system 200 includes a mobile device 220 that includes a shopping application 221, a processor 222, one or more cameras 223, a transceiver 224, an image storage 225, a visual recognition software 227, a notification generator 228 and a display 229. In exemplary embodiments, the processor 222 is configured to execute the shopping application 221. The shopping application 221 receives a list of items from a user and determines if the image storage 225 includes an image of the item. If the image storage 225 does not include an image of the item, the mobile device 220, via the transceiver 224, communicates with an application server 230 to obtain an image of the item from a product image database 232. If the product image database 232 includes an image of the product, it is retrieved and stored in the image storage 225. Otherwise, a user may be prompted to capture an image of the product with the camera 223 or provide a picture via upload. Alternatively, the mobile device 220 may not include image storage 225 and always access product image database 232 for locating items.

Once a user has entered their personal shopping list and entered a store, the shopping application 221 can be entered into a shopping mode in which the shopping application 221 captures images of the store shelves using the one or more cameras as the user traverses the aisles of the store. Although primarily discussed as capturing images of shelves, it will be clear to those of ordinary skill in the art that the images need not be of shelves but can be any images that contain items in a store, such as a product display, in a bin, on a hanger, on a hook, on the floor, etc. The shopping application 221 utilizes visual recognition software 227 to process the images captured by the cameras 223. The visual recognition software 227 is configured to compare the images captured by the cameras 223 with the images of the products on the personal shopping list, which are stored in the image storage 225. Upon detection of the presence of a product on the personal shopping list in one of the captured images, the notification generator 228 creates a notification that an item from the personal shopping list has been found. In exemplary embodiments, the notification can be an auditory notification or a visual notification. In some embodiments, the notification can include displaying, on a display 229 of the mobile device 220, an image of the store shelf that includes a highlighting of the location of the identified product. In another embodiment, the display 229 may enter an augmented reality mode to highlight or direct the user's attention to the identified product.

In exemplary embodiments, the visual recognition software 227 can recognize a product on the personal shopping list in multiple shapes/sizes and notify the customer of all options. If the user specifies a specific size, the visual recognition software 227 can look for specific images, labels, or estimate size such that the notifications match the specific item that the user desires. In exemplary embodiments, the visual recognition software 227 may also analyze and interpret signs, tags, etc. and notify a user if the text or barcode matches a desired product to let them know that the product appears to be sold out. At this point, the shopping application 221 may suggest the same product in a different size or alternative similar products if the user desires to replace an item on their original shopping list. The shopping application 221 may recognize generic products written on a shopping list (e.g., ketchup) and notify a user when any brand of that product is recognized. The shopping application 221 may also remember prior data (e.g., brand, size, etc.) that was purchased when a customer had added a generic product to their personal shopping list such that the notification is only triggered when that product is recognized (e.g., if a customer previously added ketchup to their personal shopping list and purchased a 38 oz bottle of Heinz ketchup, the customer may be notified when the visual recognition software 227 recognizes that same size bottle of Heinz even though the customer only wrote ketchup on their personal shopping list). The shopping application 221 may recognize the item that was purchased based on visual recognition of the item taken by the user or with additional input such as analysis of a digital receipt or via a picture of the receipt. Optionally, the store may choose to be linked to the shopping application 221 to share inventory status (e.g., the item may be in the store room) or provide a way for the customer to contact store employees from the location of the possibly sold out item.

In exemplary embodiments, the system 200 may include a shopping cart 210 that can include a mounting bracket configured to receive the mobile device 220 such that the front facing camera points to the left and the rear camera points to the right (or vice versa). In various embodiments, the mounting bracket may be built into the cart or it may be a simple clip feature. In some embodiments, the shopping cart 210 may include one or more cameras 212, a processor 216, and a transceiver 214. The transceiver 214 is configured to communicate with the mobile device 220 and to transmit images captured by the camera 212. The shopping cart 210 may communicate either via a wired or wireless connection with the mobile device 220. Alternatively, the shopping cart may include some or all of the components of mobile device 220 such that the user may log into their account on the shopping application 221 to receive their personal shopping list, that was created prior to their visit to the store, and the shopping cart could communicate directly with the server (e.g., via the stores Wi-Fi) without the need for mobile device 220.

In exemplary embodiments, the product image database 232 stored on the application server 230 includes the names and images of a wide variety of products. In addition, multiple images may be stored for certain products to capture different angles, packages, sizes, etc. Furthermore, barcodes or SKUs for specific stores may also be stored in the database. All data may be uploaded on the shopping application backend, via accounts from brands, companies, or product owners, via the community of users that continuously upload and identify products, or a combination.

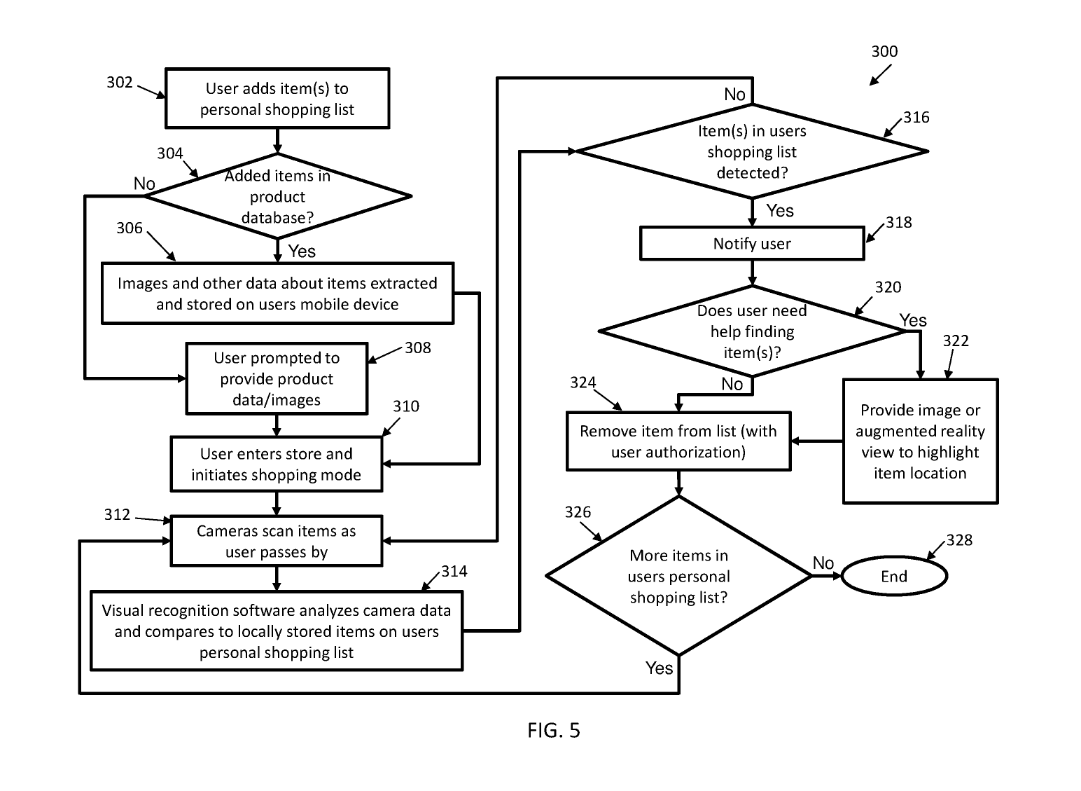

Referring now to FIG. 5, a flow diagram is shown of a method 300 for locating items in a store from a personal shopping list in accordance with an exemplary embodiment. As shown at block 302, the method 300 includes a user adding items to a personal shopping list. In exemplary embodiments, a user may manually enter items using a user interface of the mobile device or the items may be added to the personal shopping list by a smart fridge or another similar device. Next, as shown at decision block 304, the method 300 includes determining if the added items are found in the product image database. If the added items are not found in the product database, the method 300 proceeds to block 308. Otherwise, the method 300 proceeds to block 306 and images and other data about items extracted from the product database are stored on user's mobile device. At block 308, the method 300 includes prompting a user to provide product images and data regarding the added item. A user may upload a picture of the item (e.g., by taking a picture of the item that they own that may be running low) or by linking to images found online.

Continuing with reference to FIG. 5, as shown at block 310, the method 300 includes a user entering a store and initiating a shopping mode of the shopping application on the mobile device. During shopping mode, one or more cameras, either disposed on the mobile device or on a shopping cart, scan items on shelves of the store as the user traverses the aisles, as shown at block 312. Next, as shown at block 314, the method 300 includes visual recognition software analyzing images captured by the cameras and comparing it to locally stored images of items on users personal shopping list. Alternatively, the mobile device may compare the captured images to items stored on the server or the captured images may be uploaded to the server where the server may perform the analysis. Next, as shown at decision block 316, the method 300 includes determining if an item in the personal shopping list has been detected. If an item in the personal shopping list has been detected, the method 300 proceeds to block 318 and notifies the user. Otherwise, the method 300 returns to block 312 and continues to capture images from the cameras.

Next, as shown at decision block 320, the method 300 includes determining if the user needs help locating the identified item on the store shelf. If the user needs help locating the identified item on the store shelf, the method 300 proceeds to block 322 and provides an image or augmented reality view of the store shelf that highlights the location of the identified item. Otherwise, the method 300 proceeds to block 324 and removes the identified item from the personal shopping list. In exemplary embodiments, the removal of the identified item from the personal shopping list may require authorization from the user. Next, as shown at decision block 326, the method 300 includes determining if the personal shopping list includes any additional items. If the personal shopping list does not include any additional items, the method concludes at block 328 and may optionally generate a notification to the user that all of the items on the list have been identified. Otherwise, the method returns to block 312 and continues to capture images from the cameras in search of the remaining items on the users personal shopping list.

In one embodiment, the mobile device is configured to locally store the images of the products on the personal shopping list. By storing the images locally, the mobile device can work in offline mode when the user is at the store and may have poor cellular service. In another embodiment, the mobile device may work in online mode and pull images from an online product database in real time as the user shops. By not storing the images locally storage space on the user's mobile device can be saved.

Although primarily discussed above with reference to locating items on a personal shopping list in a store, those of ordinary skill in the art will appreciate that the methods and systems described can be used in a variety of other applications. For example, the list of items may be a list of items that a worker in a warehouse needs to pick from the shelves in a warehouse or a list of books that an individual wants to find at a library, or the like.

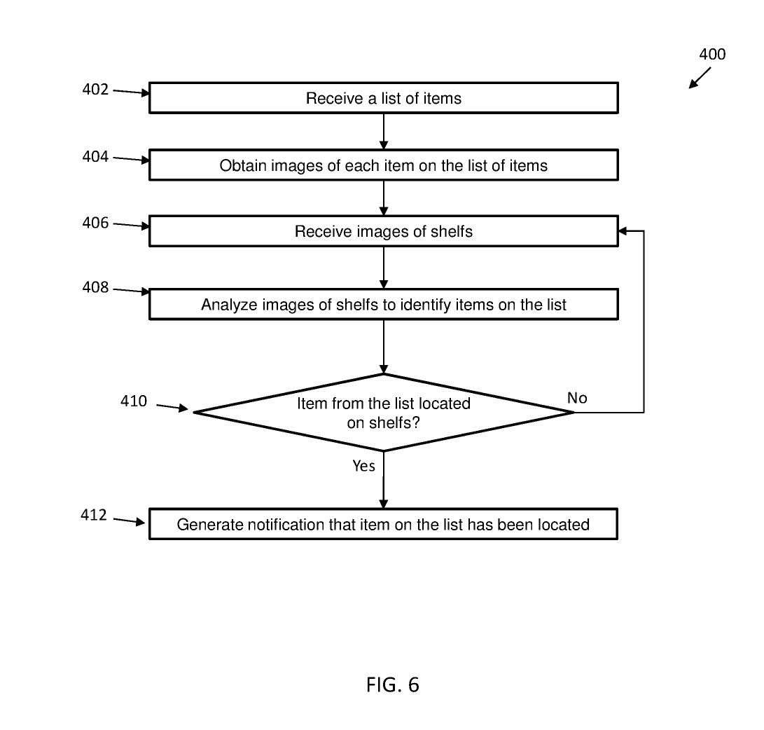

Referring now to FIG. 6, a flow diagram is shown of a method 400 for locating items on a list in accordance with an exemplary embodiment. As shown at block 402, the method 400 includes receiving a list of items. Next, as shown at block 404, the method 400 includes obtaining images of each of the items on the list. In exemplary embodiments, the images of the items can be obtained from a user or from a product database. The method 400 also includes receiving images of shelves, as shown at block 406. In exemplary embodiments, the images of one or more shelves can be received by one or more cameras of a mobile device or from one or more cameras disposed on a cart in communication with the mobile device.

Continuing with reference to FIG. 6, the method 400 also includes analyzing images of shelves to identify items on the list, as shown at block 408. In exemplary embodiments, analyzing the images of one or more shelves to identify items on the list includes comparing the images of the items on the list to the images of one or more shelves. Next, as shown at decision block 410, the method 400 includes determining if an item from the list has been located on a shelf. If an item from the list has been located on a shelf, the method 400 proceeds to block 412 and generates a notification that an item on the list has been located. Otherwise, the method 400 returns to block 406. In exemplary embodiments, the notification can include an indication of the identified item on the list that was identified and can also include an indication of a location of the identified item on one or more shelves. Optionally, the method 400 can include removing the identified item from the list after it has been located on the store shelf.

In one embodiment, the list of items can include one or more items that a store employee needs to restock and the list can be created by scanning the UPC's of the items or by taking pictures of the items. The mobile device can then scan the shelves as the worker makes their way through the store to let the worker know where to re-stock the items. In this embodiment, the mobile device can be configured to scan the tags on the shelves as well as the items on the shelves to identify the proper place for the items.

In another embodiment, the application can be configured to scan the items on the store shelves and compare them to the tags on the store shelves or to other nearby items (e.g., one box of cereal may be identified at not belonging in the frozen food section) to identify potentially misplaced items, or out of stock items. In exemplary embodiments, the application can be configured to communicate with inventory management system of the store and can be used to alert the store of low or out of stock items.

In exemplary embodiments, the images captured by mobile devices as they traverse the aisles of a store can be uploaded and stored such that a virtual map of the store can be created. The images can be updated each time a user traverses the aisles and can be used to identify items when the view of a camera of a mobile device is blocked by another shopper, or other obstruction.

In exemplary embodiments, the visual recognition software is configured to identify when a recognized item is in another person's cart, being held in their hand, or in another shopper's basket, as opposed to being located on a shelve or display, such that the user is only notified when the item is located in a location in which the user can obtain the item from, i.e., a shelve, a display, a bin, or the like. In this way, the visual recognition software will not notify a user if another shopper has an item on the user's list in their cart.

In exemplary embodiments, recurring items and patterns may be recognized over time such that a user can be notified if they pass by an item that is not on their list, but that the application expects that they may want (e.g., a user buys milk once a week, but happened to forget to put it on their list once.)

In exemplary embodiments, the application can be configured to notify a user if there is a coupon for an item, or if the store is having a sale on an item, that they have purchased in the past or for an item similar to something on their list to help the user save some money. If the user declines the alternate choice that has a coupon, this info can be stored such that the application will not offer that again in the future if the same or similar coupon is available.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for locating items in a store from a personal shopping list, the computer implemented method comprises:
receiving, by a processor of a mobile device, a personal shopping list;
obtaining images of items on the personal shopping list;
receiving, by the processor of the mobile device, images of one or more shelves in the store;
analyzing the images of one or more shelves in the store to identify items on the personal shopping list; and
based on a determination that an identified item on the personal shopping list has been located in one of the images of the one or more shelves, generating a notification that the identified item has been located.

2. The computer implemented method of claim 1, wherein analyzing the images of one or more shelves in the store to identify items on the personal shopping list includes comparing the images of the items on the personal shopping list to the images of one or more shelves in the store.

3. The computer implemented method of claim 1, wherein the notification includes an indication of the identified item on the personal shopping list that was identified.

4. The computer implemented method of claim 3, wherein the notification also includes an indication of a location of the identified item on one or more shelves.

5. The computer implemented method of claim 4, wherein the indication of the location is provided via a picture with the item highlighted or via a highlighted item in an augmented reality mode on the mobile device.

6. The computer implemented method of claim 1, wherein one or more of the images of items on the personal shopping list are obtained from a user.

7. The computer implemented method of claim 1, wherein one or more of the images of items on the personal shopping list are obtained from a product database.

8. The computer implemented method of claim 1, wherein the images of one or more shelves in the store are received by one or more cameras of the mobile device.

9. The computer implemented method of claim 1, wherein the images of one or more shelves in the store are received by one or more cameras disposed on a shopping cart in communication with the mobile device.

10. The computer implemented method of claim 1, further comprising removing the identified item from the personal shopping list.

11. A computer program product for locating items in a store from a personal shopping list, the computer program product comprising:
a storage medium readable by a processing circuit and storing instructions for execution by the processing circuit for performing a method comprising:
receiving, by a mobile device, a personal shopping list;
obtaining images of items on the personal shopping list;
receiving images of one or more shelves in the store;
analyzing the images of one or more shelves in the store to identify items on the personal shopping list; and
based on a determination that an identified item on the personal shopping list has been located in one of the images of the one or more shelves, generating a notification that the identified item has been located.

12. The computer program product of claim 11, wherein analyzing the images of one or more shelves in the store to identify items on the personal shopping list includes comparing the images of the items on the personal shopping list to the images of one or more shelves in the store.

13. The computer program product of claim 11, wherein the notification includes an indication of the identified item on the personal shopping list that was identified.

14. The computer program product of claim 13, wherein the notification also includes an indication of a location of the identified item on one or more shelves.

15. The computer program product of claim 11, wherein one or more of the images of items on the personal shopping list are obtained from a user.

16. The computer program product of claim 11, wherein one or more of the images of items on the personal shopping list are obtained from a product database.

17. The computer program product of claim 11, wherein the images of one or more shelves in the store are received by one or more cameras of the mobile device.

18. A mobile device for locating items in a store from a personal shopping list, the mobile device comprising a processor in communication with one or more types of memory, the processor configured to:
receive a personal shopping list;
obtain images of items on the personal shopping list;
receive images of one or more shelves in the store;
analyze the images of one or more shelves in the store to identify items on the personal shopping list; and
based on a determination that an identified item on the personal shopping list has been located in one of the images of the one or more shelves, generate a notification that the identified item has been located.

19. The mobile device of claim 18, wherein analyzing the images of one or more shelves in the store to identify items on the personal shopping list includes comparing the images of the items on the personal shopping list to the images of one or more shelves in the store.

20. The mobile device of claim 18, wherein the notification includes an indication of the identified item on the personal shopping list that was identified.
